(19) United States
(12) Patent Application Publication
(10) Pub. No.: US 2003/0214170 A1
(43) Pub. Date: Nov. 20, 2003

(54) Motor vehicle seat having curved headrest guide

(76) Inventors: John E. Schambre, Canton, MI (US); Marcus G. Washington, Southfield, MI (US); Jack Soullier, Troy, MI (US); Liliana Neag, Walled Lake, MI (US); Louis D. DeLellis, South Lyon, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/146,362

(22) Filed: May 15, 2002

(51) Int. Cl. B60N 2/48

(52) U.S. Cl. 297/410

(57) ABSTRACT

A guide assembly for a headrest having at least one support comprises a track having a first plurality of openings and a second plurality of openings spaced from the first plurality of openings. A first set of ball bearings is disposed in the first plurality of openings, and a second set of ball bearings disposed in the second plurality of openings. The first and second sets of ball bearings engage the at least one support.

### TECHNICAL FIELD OF THE INVENTION

This invention relates generally to seat for motor vehicles, and relates more specifically to a curved guide for the headrest of a motor vehicle seat.

### BACKGROUND OF THE INVENTION

Many motor vehicles, particularly sport utility vehicles, are equipped with rear seats that can be moved from a seating configuration, in which passengers can sit in the seat, to a so-called “load floor” configuration where the back support of the seat is folded downwardly to assume a horizontal orientation and thereby facilitate cargo stowage in the van. Typically, locking mechanisms are provided for holding the seat in the seating configuration, and the locking mechanisms can be released to permit moving the seat to the load floor configuration.

Various arrangements have been proposed for retracting a headrest of the seat in order to provide the seat with a more compact profile when folded. For example, U.S. Pat. No. 5,826,942 shows a vehicle seat assembly with an adjustable headrest. The headrest is coupled to a lower seatback latch such that upon rotation of the headrest to a stored position, the lower seatback latch is released, enabling the seatback to then be rotated to its stored position.

### SUMMARY OF THE INVENTION

The present invention is a guide assembly for a headrest having at least one support. The guide assembly comprises a track having a first plurality of openings and a second plurality of openings spaced from the first plurality of openings. A first set of ball bearings is disposed in the first plurality of openings, and a second set of ball bearings disposed in the second plurality of openings. The first and second sets of ball bearings engage the at least one support.

Accordingly, it is an object of the present invention to provide an assembly of the type described above that allows the headrest to be raised and lowered as the seatback is pivoted.

Another object of the present invention is to provide an assembly of the type described above that allows the headrest to be raised and lowered without power.

Still another object of the present invention is to provide an assembly of the type described above that allows the seatback to occupy a relatively compact space in the stowed position, without the need for undesirable cutouts or scallops in the seat cushion.

Yet another object of the present invention is to provide an assembly of the type described above which is easy to use and cost-effective.

These and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a perspective view of a frame according to the present invention for a motor vehicle seat in an upright, use position;

FIG. 2 is a perspective view of the frame in a folded position;

FIG. 3 is a side view of the frame in the upright position;

FIG. 4 is a side view of the frame in the folded position; and

FIG. 5 is a perspective view of a headrest for use with the frame.

### DETAILED DESCRIPTION OF THE PRESENTLY PREFERRED EMBODIMENTS

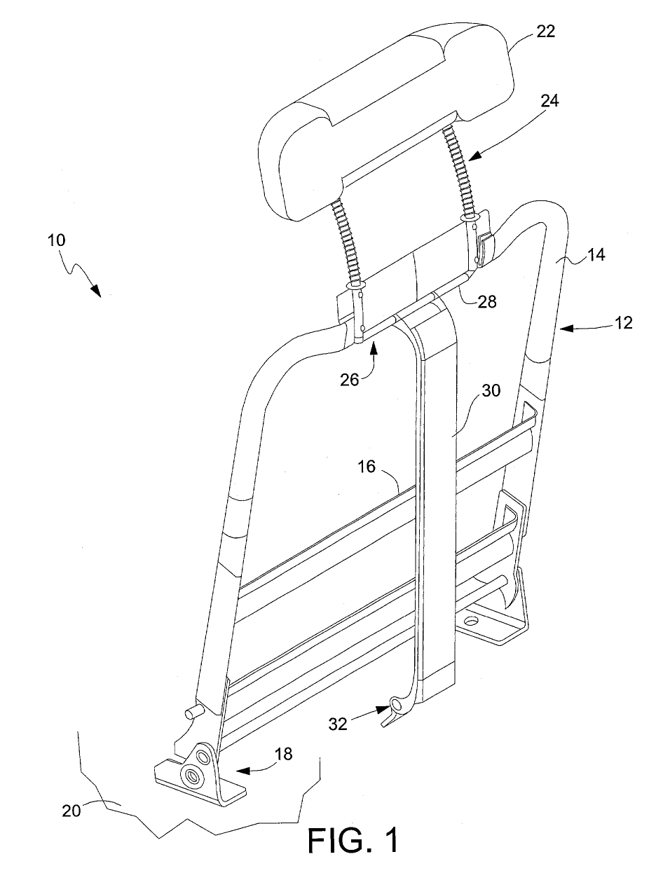

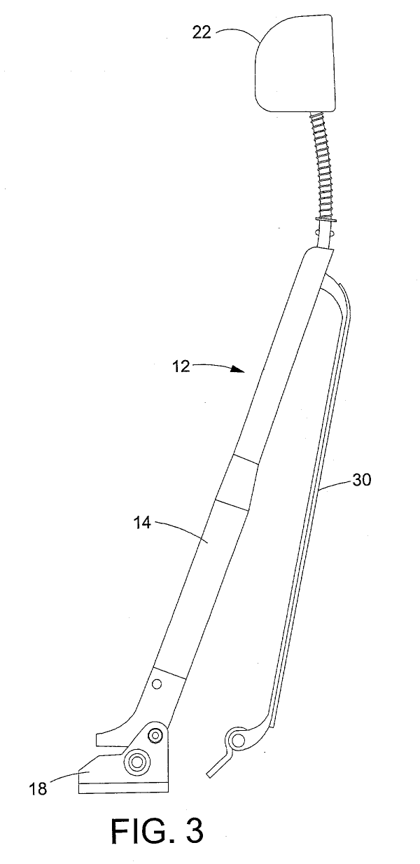

FIGS. 1 through 4 show one embodiment 10 of a frame assembly according to the present invention for a motor vehicle seat. The seat frame assembly 10 includes a seatback frame 12 that may be formed of any conventional material and covered, although not shown, with a conventional foam cushion and seat cover. The seatback frame 12 preferably includes a pair of side members 14, and one or more braces 16 extending between the side members. The lower end of each side member 14 is mounted to a pivot 18, which in turn is secured to an interior load floor 20 of the motor vehicle in any known fashion. Alternatively, the pivot 18 may be attached to the frame of a generally horizontally disposed seat cushion upon which an operator of the vehicle may sit, as is also well known.

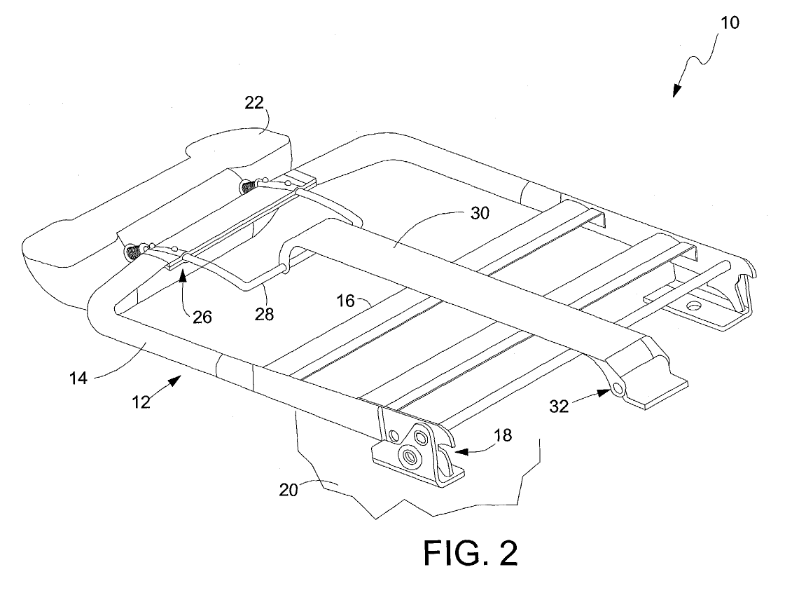

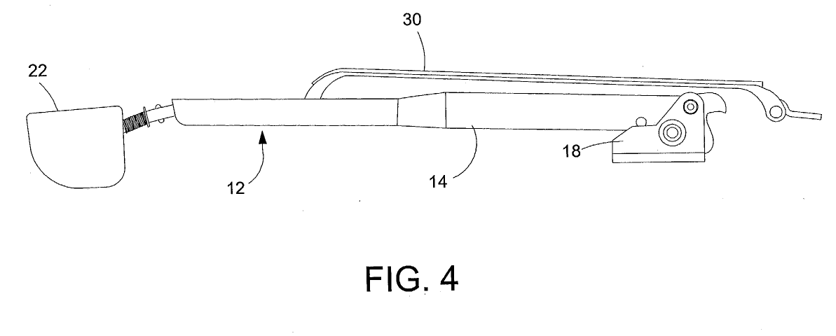

The seatback frame 12 is pivotable about the pivot 18 between a relatively upright, operational position and a lowered, storage position shown in FIGS. 2 and 4 generally parallel to the load floor. In the upright position, a headrest 22 is spaced above the top of the seatback frame 12 by one or more curved supports 24. The supports 24 engage a guide assembly 26, which is disposed between the side members 14 and forms the upper part of the seatback frame 12. The guide assembly 26 includes a lateral rod 28 that engages a headrest actuator 30. The rod 28 is fixed against rotation relative to the supports 24, and extends through holes in the upper end of the actuator 30 or is otherwise rotatably mounted relative thereto. The rod 28 may be provided with a bearing sleeve to minimize rotational friction between the rod and the actuator 30. Alternatively, the rod 28 may be formed as an integral piece with the actuator 30 welded thereto, or otherwise fixed against rotation relative to the actuator, with the rod rotatable relative to the supports 24.

The actuator 30 is preferably a metal or plastic bar with both compressive and tensile strength, and is connected at its lower end to a fixed pivot 32 spaced some distance rearwardly of the axis defined by the pivots 18. When the seatback frame 12 is rotated from its upright position to its lowered position, the bar actuator 30 retains the rod 28, and thus the supports 24 and the headrest 22, at a constant length from the pivot 32. As a consequence, the supports 24 are drawn through the vertical portions of the guide assembly 26, and the headrest 22 is drawn closer to the top of the seatback 12.

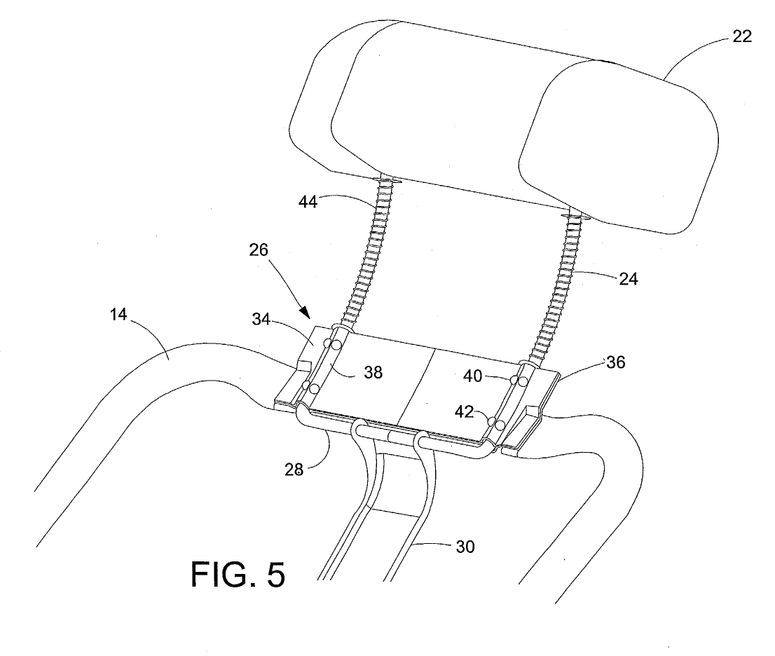

FIG. 5 shows the headrest 22 in greater detail. In a preferred embodiment, the guide assembly 26 includes a front plate 34 and a rear plate 36. Each of the plates 34 and 36 includes a pair of semicylindrical tracks 38 having a radius of curvature matched to the radius of curvature of the supports 24. A plurality of circular openings is formed in the tracks 38 at each of spaced apart upper and lower locations in order to retain ball bearings. In a preferred embodiment, three ball bearings 40 are retained at each of the two upper locations, and three ball bearings 42 are retained at each of the lower locations.

The supports 24 are concave or generally curved toward the front of the headrest 22. Means such as springs 44, acting between the top of the plates 34 and 36 and the bottom of the headrest 22, may be provided to bias the headrest away from the top of the seat frame. The springs 44 also tend to bias the seatback frame 12 toward the upright position. Latching mechanisms, not shown, may also be provided to latch the seatback in either or both of the upright and stowed positions.

When the headrest 22 is drawn downwardly by the bar actuator 30 as the seatback frame 12 is pivoted forwardly, the supports 24 slide through the tracks 38 on the ball bearings 40 and 42. The headrest 22 desirably rests against the top of the cushion overlying the seatback frame 12 when the seatback is pivoted forward to the greatest extent possible in the particular implementation.

The present invention thus provides a headrest that may be raised and lowered, without power, as the seatback is pivoted. With the headrest in the stowed position, the seatback occupies a relatively compact space without the need for undesirable cutouts or scallops in the seat cushion.

While the embodiment of the invention disclosed herein is presently considered to be preferred, various changes and modifications can be made without departing from the spirit and scope of the invention. The scope of the invention is indicated in the appended claims, and all changes that come within the meaning and range of equivalents are intended to be embraced therein.

1. A guide assembly for a headrest having at least one support, the guide assembly comprising:
a track having a first plurality of openings and a second plurality of openings spaced from the first plurality of openings;
a first set of ball bearings disposed in the first plurality of openings; and
a second set of ball bearings disposed in the second plurality of openings;
the first and second sets of ball bearings engaging the at least one support.

2. The guide assembly of claim I further comprising an actuator operably engaged with the support.

3. The guide assembly of claim 2 wherein the actuator comprises a bar.

4. The guide assembly of claim 2 wherein the actuator is operably engaged with a fixed pivot.

5. The guide assembly of claim 1 further comprising a spring bearing against the headrest.

6. The guide assembly of claim 5 wherein the spring biases the headrest away from the track.

7. The guide assembly of claim 1 wherein the support is curved.

8. A guide assembly for a motor vehicle seat, the guide assembly comprising:
a headrest having at least one support;
a track having a first plurality of openings and a second plurality of openings spaced from the first plurality of openings;
a first set of ball bearings disposed in the first plurality of openings; and
a second set of ball bearings disposed in the second plurality of openings;
the first and second sets of ball bearings engaging the at least one support.

9. The guide assembly of claim 8 further comprising an actuator operably engaged with the support.

10. The guide assembly of claim 9 wherein the actuator comprises a bar.

11. The guide assembly of claim 9 wherein the actuator is operably engaged with a fixed pivot.

12. The guide assembly of claim 8 further comprising a spring bearing against the headrest.

13. The guide assembly of claim 12 wherein the spring biases the headrest away from the track.

14. The guide assembly of claim 8 wherein the support is curved.

15. A seat for a motor vehicle, the seat comprising:
a headrest having at least one curved support;
a track having a first plurality of openings and a second plurality of openings spaced from the first plurality of openings, the track being curved to match the curved support;
a first set of ball bearings disposed in the first plurality of openings; and
a second set of ball bearings disposed in the second plurality of openings;
the first and second sets of ball bearings engaging the at least one support.

16. The seat of claim 15 further comprising an actuator operably engaged with the support.

17. The seat of claim 16 wherein the actuator comprises a bar.

18. The seat of claim 16 wherein the actuator is operably engaged with a fixed pivot.

19. The seat of claim 15 further comprising a spring bearing against the headrest.

20. The seat of claim 19 wherein the spring biases the headrest away from the track.
